(19) United States
(12) Patent Application Publication
(10) Pub. No.: US 2005/0184517 A1
(43) Pub. Date: Aug. 25, 2005

(54) Pipe coupling

(76) Inventor: Ajit Singh Gill, Salt Lake City, UT (US)

Correspondence Address: MALLINCKRODT & MALLINCKRODT, 10 EXCHANGE PLACE, SUITE 510, SALT LAKE CITY, UT, 84111, US

(21) Appl. No.: 11/113,256

(22) Filed: Apr. 22, 2005

Related U.S. Application Data
(63) Continuation-in-part of application No. 11/077,091, filed on Mar. 10, 2005.
Application No. 11/077,091 is a continuation-in-part of application No. 10/665,089, filed on Sep. 17, 2003.
Application No. 10/665,089 is a continuation-in-part of application No. 10/654,666, filed on Sep. 4, 2003.

(51) Int. Cl. F16L 35/00

(52) U.S. Cl. 285/308

(57) ABSTRACT

A coupling to connect pipe, including lengths of pipe, valves, hoses, and pipe and hose fittings, includes a body to closely receive the end portion of the pipe to be coupled and jaw members to secure the pipe to be coupled in the coupling. The coupling includes an internal groove extending at least partially around the pipe end portion when received in the coupling. The jaw members are mounted to the coupling body to establish a fulcrum for rotation of each lever jaw member about the fulcrum between an engaged position and a disengaged position with respect to the pipe end portion when received in the coupling body. At least a portion of the jaw members are positioned in the coupling internal groove. Additionally or alternately, jaw members may be provided adapted to slide along the inner groove in the coupling body to move between a position spaced radially from the received pipe to allow the pipe to move into or out of the coupling body and a position securing the pipe in the coupling body. An insert may be provided to lock the jaw members in position. The ends of the pipes to be joined can be configured for use with the coupling by the attachment of special rings to the end portions of the pipes.

### RELATED APPLICATIONS

This is a continuation-in-part of copending application Ser. No. 11/077,091, filed Mar. 10, 2005, entitled Pipe Coupling, which was a continuation-in-part of copending application Ser. No. 10/665,089, filed Sep. 17, 2003, entitled Pipe Coupling, which was a continuation-in-part of application Ser. No. 10/654,666, filed Sep. 4, 2003, also entitled Pipe Coupling.

### BACKGROUND OF THE INVENTION

1. Field

The invention is in the field of couplings to connect grooved or plain end portions of pipes, and to connect hoses, valves, pipe fittings, expansion joints, dead ends of pipes, and covers, lids, and bottoms of pressure vessels. The invention also applies to connecting structural piping or other structural members.

2. State of the Art

There are various types of mechanical couplings which employ various radial mechanical means, such as clamps and rings to secure the couplings to circumferential grooves on the ends of two pipes being connected. There are also my couplings, patented under U.S. Pat. Nos. 5,387,017 and 5,868,441, each of which employ a set of camming jaw members mounted on the coupling body around the receiving opening, where, to engage or to disengage, the coupling jaw members move toward or away from a pipe received in the body. There are other U.S. Pat. Nos. 5,794,988 and 6,186,560 by the inventor where expandable rings are employed to engage or to disengage the coupling. The new invented coupling is more economical to produce, and is easier than other couplings to connect plain end pipe. From here on the word pipe will encompass not only lengths of pipe, but also valves, hoses, and pipe and hose fittings where a connection is made to a pipe or other hoses or fittings.

### SUMMARY OF INVENTION

According to the invention, a coupling to connect two opposite circumferential end portions of pipe includes a coupling body with a receiving opening therein so that the coupling body closely receives and surrounds the end portion of a pipe to be coupled. The coupling body includes a radial groove therein concentric with the axis of the coupling and a pipe inserted into the coupling, and which groove is positioned over at least a portion of the pipe when the end portion of the pipe is received in the coupling body. One or more jaw member is positioned in the groove and can be moved to a position in the groove with respect to the received pipe to secure the pipe in the coupling body. The jaw member may be a rigid lever jaw member mounted in the coupling so that a portion of the lever jaw member is located inside the radial groove. A portion of the lever jaw member preferably extends to the outside of the coupling body so that the jaw member can be operated from outside the coupling body.

In one embodiment, as shown and described in the referenced priority applications, the lever jaw member may be a set of lever jaw members which define a first class lever with a power arm and a weight arm. A first class lever has the fulcrum between the effort (the power arm of the lever) and the load (the weight arm of the lever). Thus, a separate power arm of the lever extends from the fulcrum of the lever and a separate weight arm extends from the fulcrum of the lever. By separate arms is meant that the power arm and weight arms are separate arms, although they may be formed by a single length of material with the fulcrum dividing the length of material into the power arm and the weight arm where the two arms have a common portion surrounding the fulcrum. In the preferred embodiment of the invention presently being described, the power arm of each set of lever jaw members is offset from the weight arm of the set of lever jaw members by an axle which forms the fulcrum of the lever. The words fulcrum and an axle will be considered as synonyms when describing this preferred embodiment. A portion of the weight arm furthest away from the fulcrum is arcuate, preferably concentric with a groove in the body of the coupling which accommodates it, which also makes it concentric with the end portion of a pipe to be coupled received in the coupling body receiving opening. The fulcrum axle at the junction of the power and weight arms is located in a gap or opening provided in the end of the coupling where the radial groove is interrupted with an opening from the radial groove to outside the coupling body. In this preferred embodiment, the power arm is situated outside the coupling body and runs approximately parallel to the weight arm situated inside the coupling body. Although the power arm and the weight arm run approximately parallel to one another, since the arms are separate and are joined at the fulcrum, the set of separate arms are considered as forming a first class lever.

The power arm of the lever jaw can be operated by a hand or hand held tool. Rotating the power arm in one direction moves the weight arm toward a pipe end portion received in the coupling body receiving opening, and rotating the power arm in the opposite direction moves the weight arm away from the pipe. Thus, the weight arm is engaged or disengaged with a pipe received in the coupling body receiving opening (the pipe having a plain surface or a groove in its end portion) by rotating the lever jaw about its fulcrum, using the power arm of the lever jaw which is preferably accessible outside the coupling body. The radial groove inside the end portion of the body of the coupling is provided with sufficient depth to accommodate the movement of the weight arm between the engaged and disengaged positions. Further, while the weight arm and power arm are approximately parallel, the arms will be offset slightly to the degree necessary so that the power arm can move the weight arm into engaged position in a groove in the pipe end inserted into the coupling body without the power arm movement being blocked by the pipe extending from the coupling.

The set of lever jaw members may be held in engaged position by arranging the power arm to frictionally engage the outer face of the coupling body. Such friction may be provided in various ways. Frictional engagement may be between the power arm against the coupling end face along its length or a portion of its length or by a friction portion extending from the power arm against the coupling end face. The friction portion may extend from the power arm in the form of a tab or may be a screw threaded through the power arm which can be extended against the coupling body face to provide the friction to hold the power arm in place. Alternately, a screw could be screwed into an aligned threaded or non-threaded receiving hole in the connector body end face when the power arm is in engaged position to positively lock the power arm in place. Depending upon the situation, it may be necessary or unnecessary to employ locking screws with the coupling when used with grooved or plain end pipe. Alternately, the weight arm can be held in engaged position by a screw extending longitudinally into the radial groove in the coupling body which holds the weight arm in engaged position, or by a bolt extending radially into the radial groove in the coupling body to lock the weight arm in engaged position.

The end portion of the coupling body which includes the groove in which the jaw member is located need not extend completely around the circumference of the pipe, but may extend only partially around the received pipe so the groove extends only partially around the received pipe. In such case the groove opens to outside the coupling body. The lever jaw member may be mounted in this groove, or a flat camming jaw member may be mounted in the groove such that movement of the camming jaw member results in radial movement of the camming jaw member in the groove between a position spaced radially from the pipe to allow the pipe to move into or out of the coupling body and a position in the groove securing the pipe in the coupling body. Alternately, with the groove opening to outside the coupling body, a flat jaw member without camming grooves may be inserted into the groove to secure the pipe in the coupling body or removed from the groove to allow the pipe to be inserted or removed from the coupling body.

In one preferred embodiment of the invention which is particularly adapted for use when the coupling body portion including the radial groove extends only partially around the received pipe, a single lever arm pivoted at one end to the coupling body outside the groove is used rather than the set of lever arms having separate power and weight arms. The single lever arm is operated in the manner of a third class lever with the power applied intermediate the length of the arm.

For different applications of the coupling, different types of gaskets are provided between the coupling and pipe end portions. In some application conventional “O” rings or other gaskets may be used with the coupling. At least one gasket is provided for the coupling to seal the exit of fluid from the pipes being joined. A predetermined length of gap between the ends of two pipes being joined may be provided for thermal expansion and to maintain the integrity of the gasket seal.

### THE DRAWINGS

The best mode presently contemplated for carrying out the invention is illustrated in the accompanying drawings, in which:

FIG. 12, a transverse section similar to that of FIG. 8, but showing a lever jaw in combination with a flat plate arcuate jaw;

FIG. 13, a transverse section similar to that of FIG. 8 but showing an alternate design of jaws;

FIG. 14, a transverse section similar to that of FIG. 13 showing the gap between the jaws filled with a “U” jaw bridging over the coupling body with its opposite legs locked in the pipe groove 22;

FIG. 15, a front side view similar to FIG. 13 except that the power arm and the weight arm of the lever jaw J are integrated in the same plane as a monolithic unit;

FIG. 16, a longitudinal vertical section taken on line 4-4 of FIG. 15, where pipes are not shown, but only the coupling is depicted;

FIG. 17, an isolated lever jaw in FIGS. 15 and 16 is depicted;

FIG. 18, a longitudinal vertical section of two ended coupling of FIG. 16 with forward open ended “U” type two seals mounted in front of slanted faces of two rings provided at the opposite ends of two pipes;

FIG. 19, a longitudinal vertical section taken on line 5-5 of FIG. 21, where “U” type of two opposite seals are mounted in front of the vertical faces of the opposite split rings mounted around the rings embedded into the circumferential groove of the PVC, polyethylene pipe or any pipe in the similar class having high thermal coefficient of expansion;

FIG. 20, is similar to FIG. 18, except that split rings are mounted around the welded metallic rings around the metal pipe;

FIG. 21, a front view of the split ring used in FIGS. 19 and 20;

FIG. 22, a longitudinal vertical section similar to that of FIG. 20, but showing a different gasket;

FIG. 23, a longitudinal vertical section showing the pipe end sections as end shanks for attachment to flexible hose or pipe;

FIG. 24, a perspective view of the coupling of FIGS. 15, 16, and 17; and

FIG. 25, a front side view similar to that of FIG. 15, but showing an insert or bridge that can also be used.

### DETAILED DESCRIPTION OF THE ILLUSTRATED EMBODIMENT

All the drawings can be studied together. Whether the coupling is one ended (having inner groove G1 and lever jaw members J only in one end portion of the coupling body with invented means to couple pipe) or two ended (where the coupling has inner grooves G1 and G2 and lever jaw members J in both end portions of the coupling body with invented means to couple pipe) the mechanical means, such as the lever jaw members which are employed to engage the coupling with the pipe, remains the same. For different requirements, and for cost effectiveness, different types of gaskets are shown in the drawings. Therefore, more than one type of gasket may be depicted on any given pipe section illustration. It is pointed out that drawings are not to any particular scale. It is further pointed out that because of the simplicity of the drawings, if any element (such as a lever jaw or the bolt used to lock the lever jaw in place) is used more than once in the design, that element will be depicted by the same numbers and alphabets in the same drawing and in all other drawings as well.

First, the coupling for grooved end pipe, FIGS. 1 to 6, will be explained simultaneously. FIGS. 1 and 2 are the same, except that FIG. 2 shows the relative positions of weight and power arms with respect to each other. As shown in FIG. 1, the coupling has body C with outer diameter C1 and inner diameter C2. The depth of the inner groove G1, which is used to accommodate lever jaws J, is depicted by the height between inner diameters C2 of the coupling body and groove diameter 31. The coupling C is shown to engage pipe 14 with inner and outer diameters 20 and 21 respectively. The two ends of lever J are shown by J1 and J2. Concentric with the coupling, an arcuate portion J4, of lever jaw J, is delineated by J2, J6 and J7. J4 is concentric with the coupling body, with the pipe, with the inner groove in the body of the coupling, and with the groove in the outer surface of the pipe. The section between J7 and J9 diverges from said arcuate section J4, by making an interior angle at J7 with J4, outward and away from the center of the coupling to the fulcrum and integral axle J3 of the lever jaw. The power arm J8 shown in FIGS. 2, 3, 5 and 6 between J3 and J12, exits out of the coupling by making an offset interior angle with the weight arm at J9. The weight arm J5 and the power arm J8 are kept apart by means of circular stem J15 shown in FIG. 3. The power arm J8 preferably is replica of the weight arm J5. The section between the power arm between J11 and J18 (shown in FIG. 3) diverges from the arcuate section J8 by making an interior angle at J11 with J8. Lever jaw J is held in position to coupling body C by means of a fulcrum integral axle J3, located in a cut delineated by cut sides 32, 33, and 34, where groove G1 is also interrupted. The power arm J8, between J3 and J12, rotates the weight arm from J3 to J2, about the fulcrum J3. The portion of lever jaw J4, between J2 and J6, is designed to engage the groove of the pipe. The groove on the end portion of the pipe is indicated by 22.

Optional radial bolts may be provided to secure the unlocking of the power arms j8, but the power arms may be locked in place by friction fit against the outer faces F1 and F2 of the coupling body. Alternatively, secure locking of the lever arms may be accomplished by securing a locking bolt n1 extending through the power arm of the lever with a hole therethrough which, when the arms are in position to secure the pipe in the coupling, aligns with a hole through the end of the coupling body extending into the groove in the coupling. The bolt n1 is inserted through the hole in the power arm and through the aligned hole in the coupling body to extend over lever jaw J and hold the weight arm and power arm in locked position as shown in FIG. 2. In low pressure pipes or hoses where frequent engaging and disengaging of the coupling is required, only one lever jaw J will be provided in the coupling. It is further pointed out that if high pressure in the pipe line requires the use of more than one or two lever jaws, then more than one or two lever jaws J will be provided for the coupling. The two pipes being connected in the Figures are shown by 14 and 14A; their outer diameters are depicted by 21 and 21A.

The mechanical means of lever jaw J has already been explained under FIGS. 1, 2, and 3. Therefore, they will not be discussed again unless the need arises, and only new elements in each Figure will be explained. In all of the drawings, the body of each coupling is shown by C, its outer diameter is shown by C1, and its inner diameter by C2. The length of each coupling between its outer opposite ends, is indicated by F1 and F2. Outer faces F1 and F2 also provide the outer walls 27 and 27A for grooves G1 and G2 respectively.

FIGS. 3 and 5 and 6 show two ended couplings, and FIG. 4 shows a one ended coupling. In FIG. 4 the one ended coupling is integrated either with a traditional pipe or with a hose shank. Whichever the case, the pipe or hose shank is shown by 14A.

To make coupling easily understood, the coupling in FIG. 3 is shown without any pipe. It depicts a longitudinal vertical section taken on line 2-2 of FIG. 2. All the elements of FIG. 3 have been discussed with FIGS. 1 and 2.

FIG. 4 employs a diaphragm type of gasket seal. Diaphragm seal 1 is provided with openings 12 and 12A to pressurize the seal with fluid in the pipe line. The outer surface 21 of pipe 14 provides a seat for gasket 1. Through cavity 19 and openings 12 and 12A, fluid reaches internal cavities 13 and 13A, and pressurizes diaphragm seal 1, thus blocking the exit of fluid between 14 and 11. The lever jaws with their weight and power arms are not shown in FIG. 4. FIG. 4 shows clearly groove G1 for the lever jaw weight arm, and the groove 22 constructed in the ring welded to the pipe or around the pipe.

FIG. 5 shows the invented coupling holding two pipes 14 and 14A together. It also shows two seal gaskets mounted over rings, which rings may be welded to the ends of the pipes or mounted around the end portions of pipes. The power arms J8 are held in place against the end faces F1 and F2 by means of a frictional fit or by means of frictional depressions provided in said faces F1 and F2. The triangular seals 47 and 47A depicted by their sides 50, 51, 52 and 50A, 51A, 52A, respectively, are mounted in corresponding triangular grooves. The seal may be a solid seal or it may be provided with a hollow interior which can be energized by the fluid in the pipe line. The fluid in cavities 53 and 53A exert pressure outwardly toward the coupling body and the fluid provided by the gap G pushes the seals outward parallel to the axis of the pipe. Thus the resultant force is such that it seals the fluid. The power jaws J8 (shown in FIG. 2) can be pried out by pushing a tool between the arm J8 and pipe. It should be understood that seals 47 and 47A can alternately be “O” ring seals placed in conventional rectangular grooves

The coupling shown in FIG. 6 is the same coupling as shown in FIG. 3. The dotted pipes 14 and 14A are merely indicative of pipes which the coupling would hold together. In FIG. 6 during the push of the two pipes 14 and 14A, the original “U” type of gasket 47 is deformed. The seal 47 is partially located in the inner coupling body and partially between the opposite ends of pipes between slanting ends 16 and 16A. In FIG. 6, gasket seal 47 is located in the corresponding cavity 52 created by the pipes 14 and 14A and the coupling C. The two sides of seal 47 are shown by 48 and 49. Fluid enters cavity 52, through gap G between pipes, and pressurizes the gasket. The original flare of the gasket, between arms 48 and 49, is reduced by slants 51 and 51A, when the pipes are pushed into the receiving openings of the coupling, during mounting.

The couplings of FIGS. 7-9 are similar to the coupling of FIGS. 1, 2, and 3. However, the ends of the coupling body have a different configuration as does one longitudinal side of the coupling body as shown in FIGS. 7 and 8. As previously described, the coupling body C of FIGS. 1, 2, and 3 has a central pipe receiving opening defined by coupling inside diameter C2 to receive therein the end portions of pipes to be coupled. The coupling body, as shown in FIG. 3, has flat ends defined at the left end by flat outer face F1 and at the right end by flat outer face F2. Internal grooves G1 and G2 in the coupling body extend completely around the central pipe receiving opening. In the embodiments of FIGS. 7-9, the configuration of the ends of the coupling body are modified by extending the grooves G1 and/or G2 only partially around the pipe receiving opening and recessing the remainder of the end face to eliminate the groove. As shown, approximately half (one hundred and eighty degrees) of the groove, between longitudinal faces or steps 32A and 34A, is eliminated. This results in a stepped configuration of the coupling ends. Thus, as shown in FIG. 7, the portion of the coupling body end that includes the groove G1 extends to the outer face F1, while the portion of the coupling body end that eliminates the groove G1 only extends to the face F3 which, in the portion of the coupling body end with groove G1, defines the inner side of groove G1. The portion of the coupling body end without the groove can be referred to as a recessed end portion while the portion of the coupling body end having the groove therein can be referred to as the grooved end portion or as a step end portion. Groove G1 opens through steps 32A and 34A to outside the coupling body. The removal of part of the coupling body ends reduces the weight of the coupling body. It also allows for various changes in the configuration of and operation of the jaw members, which will be described. Further, the grooved end portion which forms the step, if arranged in the coupling installation at the lower side of the coupling body as shown in FIG. 7, provides a resting surface upon which a pipe end to be inserted into the pipe receiving opening in the coupling body can be rested in preparation for insertion into the pipe receiving opening. In addition, when inserting the pipe end into the coupling body, the open ends of the groove in the grooved end portion, i.e., where the groove opens through faces 32A and 34A, are visible and the pipe groove can be more easily aligned with the coupling groove than when the coupling groove is entirely hidden in the coupling body.

Another difference in the coupling body as shown in FIGS. 7 and 8 from the coupling body of FIGS. 1, 2, and 3 is the thinning of the coupling body along a portion of the recessed end portion. This thinning of the coupling body is done to further reduce the weight of the coupling body and can be done because of the elimination of part of the grooved end portion of the coupling body. Because the coupling body no longer has to be thick enough through the recessed end portion of the coupling body to form a groove, the extra thickness necessary to form the groove can be removed. Thus, as shown in FIGS. 7 and 8, a section of the coupling body along a portion of the recessed end portion extending between faces 32B and 34B has been thinned. This thinned section extends along the longitudinal or axial length of the coupling body. Care needs to be taken in thinning this section that enough thickness remains to provide the necessary strength to hold the pipe ends in the coupling and withstand any stresses that may be expected between pipe ends. However, this necessary thickness is generally substantially less than the thickness needed to provide the grooves. An alternative method to reduce weight of the coupling is depicted in FIG. 9. FIG. 9 shows a rectangular section S filled with a sand casting ring which is left intact in the casting of the coupling body C. The sand casting ring is generally lighter than the metal material, such as steel, from which the connector body will generally be made.

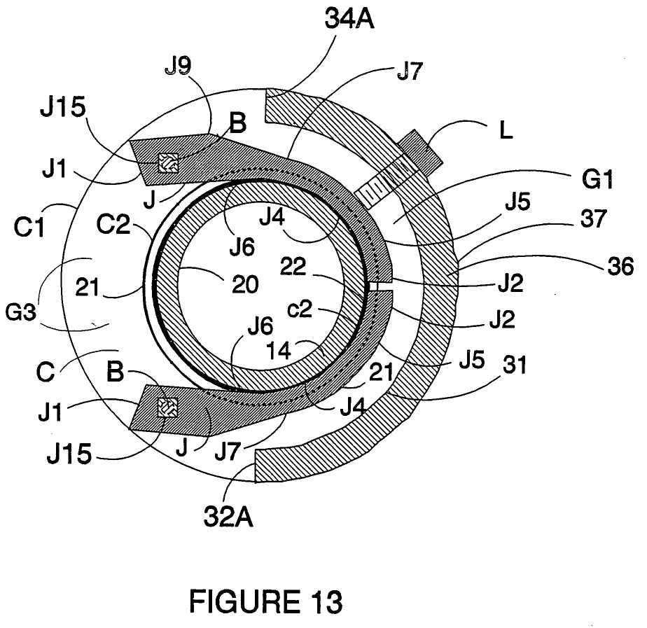

With the provision of the recessed end portion of the coupling body, various changes in the configuration of and operation of the jaw members can be made. For example, as shown in FIGS. 7 and 8, the jaw members of the coupling can be placed in mutually reversed positions next to each other. FIG. 7, similarly to the sets of lever jaw members of FIGS. 1, 2, and 3, shows the power arm J8 offset from weight arm J5 by stem 15, which is part of fulcrum integral axle J3 to which the power and weight arms are secured. Axle J3 extends into coupling body C to pivotally mount power arm J8 and weight arm J5 to coupling body C. Weight arm J5 is positioned in coupling interior groove G1. Thus, as power arm J8 is rotated about the fulcrum created by axle J3 toward the center of coupling body C, weight arm J5 also rotates toward the center of coupling body C. If a pipe end is received in coupling body C, weight arm J5 rotates into the groove in the end portion of the pipe, or if the end of the pipe is not grooved, weight arm J5 rotates into position against the outer surface of the received pipe. If the pipe is not grooved to receive the weight arm, the weight arm usually will have to be pressed against the pipe surface, such as with screw L shown in FIG. 13, to be able to hold the pipe in the coupling body. If the pipe is grooved, the screw n1 with head n shown in FIGS. 2 and 7 can be used to lock the set of lever arms in the engaged position as shown in FIG. 2. As can be seen, power arm J8 is angularly offset from weight arm J5 so that weight arm J5 will rotate into position in a pipe groove before further inward movement of power arm J8 is blocked by the received pipe.

An alternative design to connect lever jaw J to power arm J8 and to mount the lever arms is shown in FIG. 8 and the top left side of the coupling in FIG. 9. A square stem J15 is provided with a corresponding opening for a bolt B. Bolt B, shown with its head B6 and threaded stem B7, is mounted through square stem J15. Square stem J15 may be secured to J by welding or may be formed integrally with J. Threaded portion B7 is screwed into the corresponding threaded hole in coupling body C. Thus by removing the bolt B, the jaws J can be removed from the coupling.

With the stem J15, which can also be a polygonal or other shape other than a square which will prevent rotation of the power and weight arms in relation to the stem J15, the power arm J8 and weight arm J5 can each be removably positioned on stem J15, or the weight arm J5 can be secured to stem J15 and just the power arm J8 be removable. Bolt head B6, as illustrated, will hold the arms in position on stem J15. Alternately, bolt head B6 can be small enough to hold stem J15 in position, but allow the power arm to be removably placed on stem J15 when desired to move the weight arm and removed after moving the weight arm. Thus, the power arm can be positioned on stem J15 to rotate the stem and weight arm into engagement with the pipe end portion received in the coupling and then the power arm removed to leave the weight arm engaging the pipe end portion and the pipe end portioned secured in the coupling. The power arm can then be repositioned on stem J15 to rotate the weight arm out of engagement with the pipe end portion received in the coupling when it is desired to release the pipe from the coupling. Rather than the power arm taking the form of an arm as shown, the power arm can take the form of a wrench placed on stem J15 when desired to rotate the stem and the weight arm.

FIGS. 10 and 11 can be studied together. FIG. 10 shows that while one end of the coupling is provided with at least one lever jaw with power arm, the other end of the coupling can be provided with at least one camming jaw or two jaws. FIG. 10 shows one end of the coupling provided with two camming jaws depicted by j. The camming jaws j are mounted in housing groove G1 which has outer wall F1 and roof depicted by 36 having inner and outer surfaces 31 and 37, respectively. FIG. 10 depicts a transverse vertical section taken through said housing passing through camming grooves g1 and g2 in the body of the two jaws depicted by j. The arcuate length of each jaw is shown between j1 and j2. Each jaws j is movably held inside of G1 by means of frictional pins b1 and b2 driven through wall F1. Pins b1 and b2 can be bolts as well as driven through F1 into camming grooves g1 and g2. Radial flange h is welded to the end of j1 of j or that flange is constructed integrally with j. Welding is shown by W. Opening h1 is provided in flange h. A locking bolt b3, FIG. 11, is passed through opening h1 and its threaded end b4 lockingly can be driven into the coupling body C. Unlike the “U” jaws in the inventor's coupling in his U.S. Pat. No. 5,387,017; each arcuate flat jaw is moved separately in the opposite direction. Movement of the jaw in one direction by means of flange h moves the jaw out of the pipe groove 22 to free the coupling from pipe 14, and moving the jaw in the opposite direction lowers the jaw into the groove 22 to lock the coupling to pipe 14. By loosening bolt b3, each jaw j can be rotated around groove 22 by means of bolt handle b3.

The invented coupling has the distinct economical advantage of providing two couplings with the same coupling body, where two types of jaws can be used to meet the requirement and preference of the costumer.

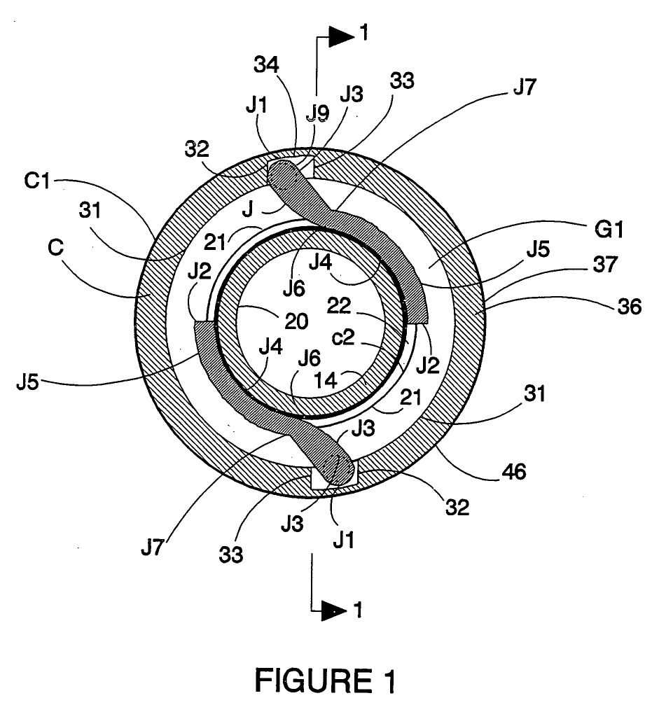

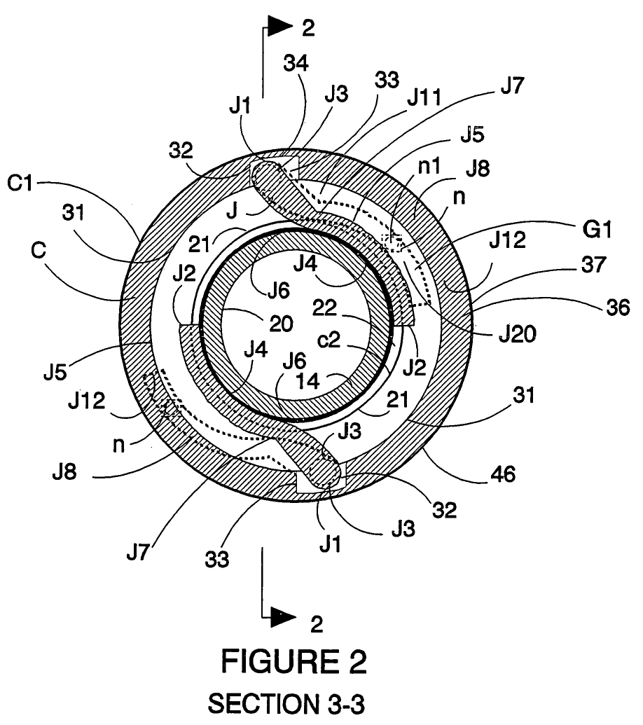

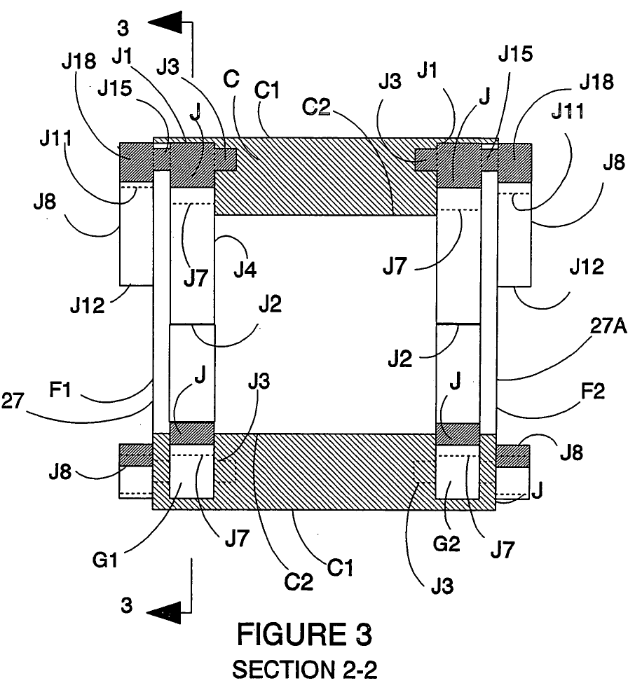

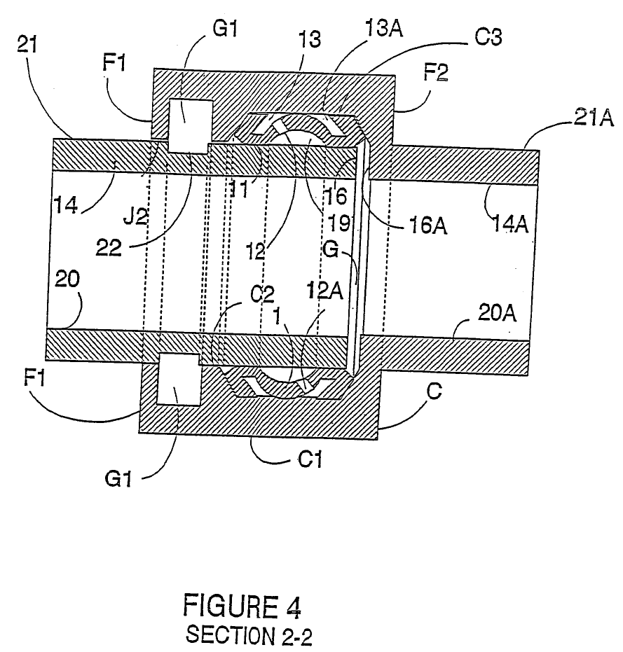

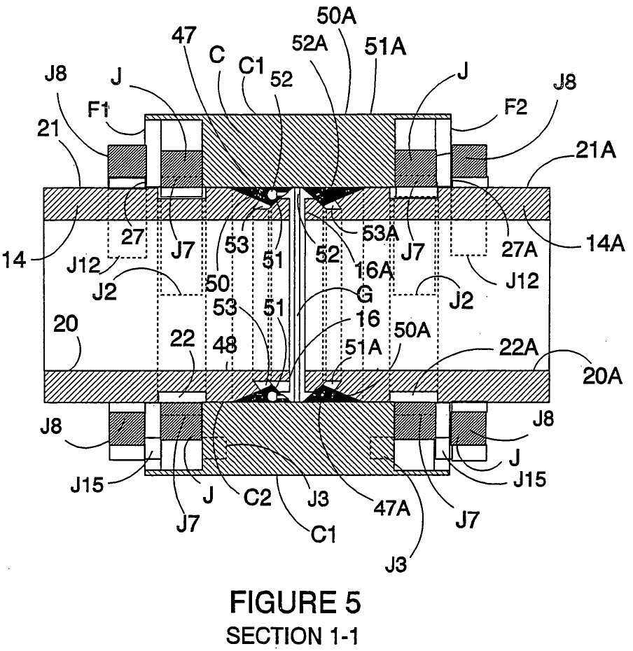

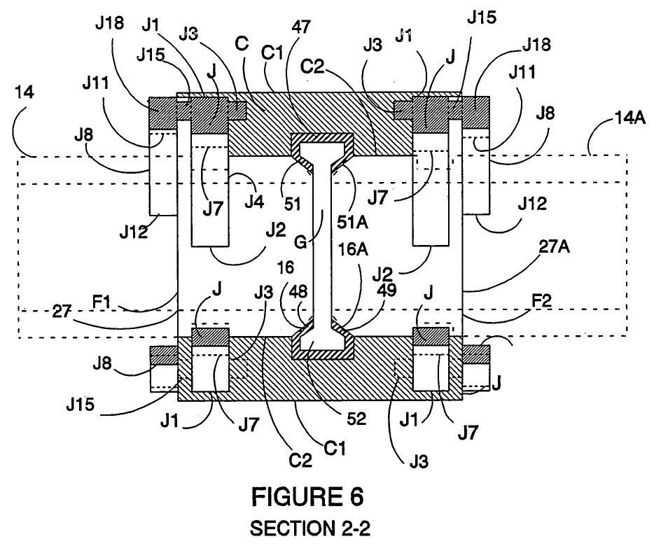

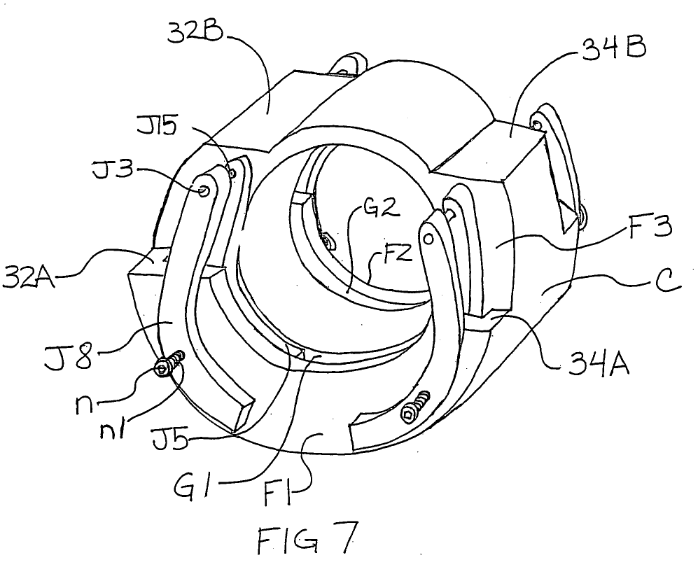

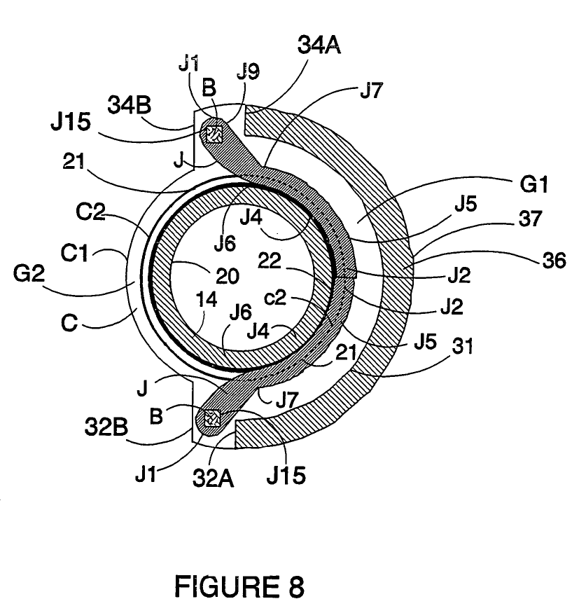

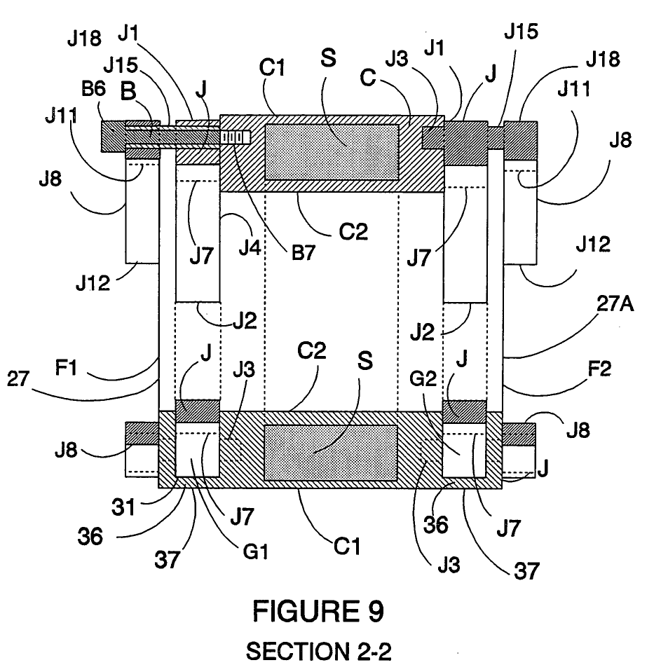

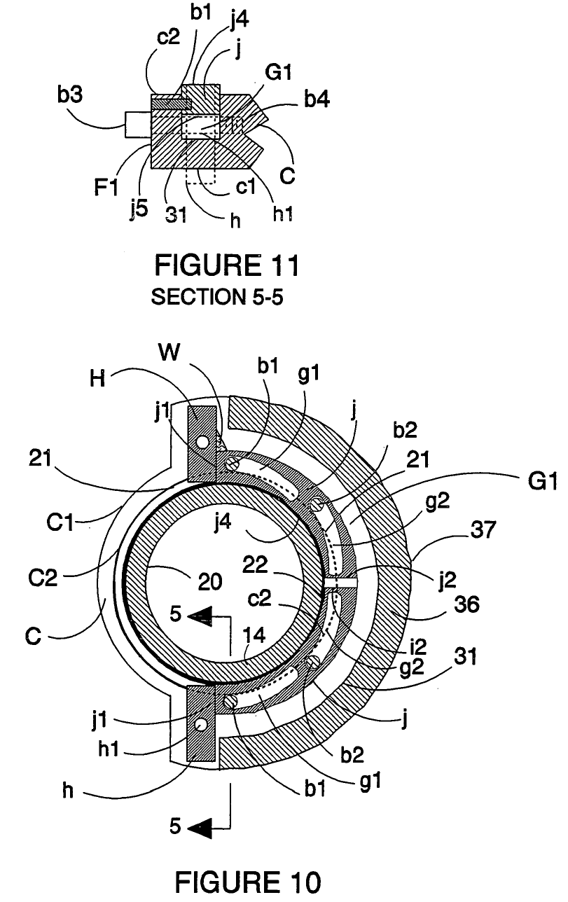

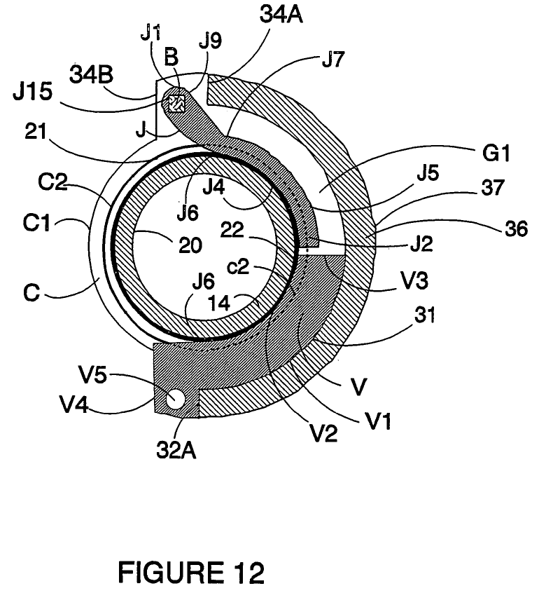

FIG. 12 shows one end of the coupling provided with one lever jaw in combination with an arcuate flat plate jaw. The flat plate jaw is shown by V having inner and outer diameters V2 and V1 respectively. An arcuate length of the jaw V is depicted by V3 and V4. The end flange V4 is provided with an opening V5 for a bolt which can lockingly can be driven into coupling body C. The flat plate arcuate jaw V can be mounted once the lever jaw J has been locked in the groove of the pipe 14. Similarly V can be released from the groove of pipe 14 before or after the lever jaw J is unlocked from the groove of pipe 14.

This invented coupling has another distinct economical advantage in that it provides a coupling with combinations of flat plate camming jaws or plan flat plate jaws, where lever jaw can be locked into the groove of the pipe very quickly and the other types of jaws are locked in after locking the lever jaw with the groove of the pipe. Thus coupling has wider range to meet the requirement and preference of the costumer.

FIG. 13 shows a modified design of jaws J similar to those of FIG. 8 where the contact length J4 of the jaws with pipe groove 22 is maximized. The jaws J's can be locked in place by bolts L which extend radially into groove G1 to abut lever jaw portions J5 when in engaged position. Bolts L are loosened to allow jaws J to be moved to disengaged position.

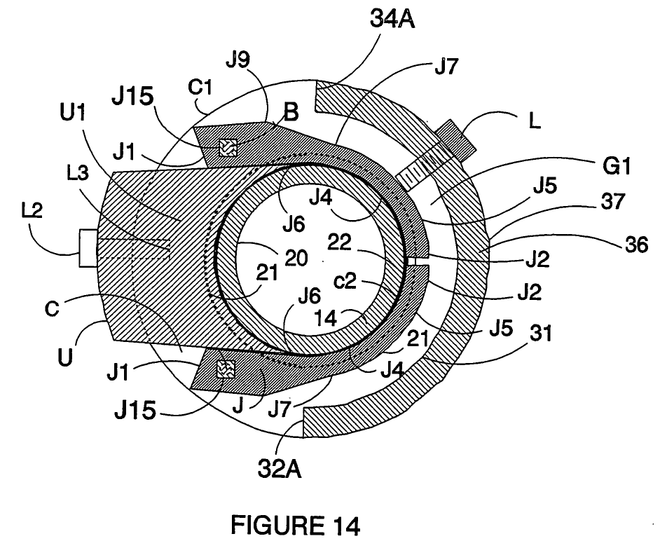

FIG. 14 is the same as FIG. 13 with the addition of an insert U inserted into and filling the gap between the two jaws J locking jaws J in place. The stem L3 of threaded bolt L2 locks the insert U to the coupling body C. The insert U can take the form of a bridging insert of “U” shape having opposite radial legs or inserts U1 on each end (only one leg or insert U1 is visible in FIG. 14) filling the gap between the two jaws J on each of the opposite ends of the coupling body C and thereby simultaneously locking the jaws J at each end of the coupling body in place. Such inserts U can be used individually or as a bridge with other embodiments of jaws, such as with the jaw embidiment of FIG. 10.

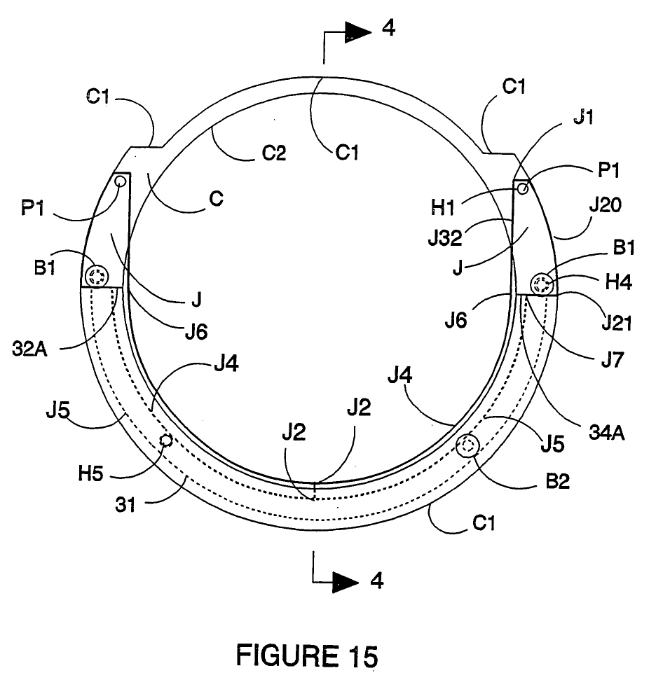

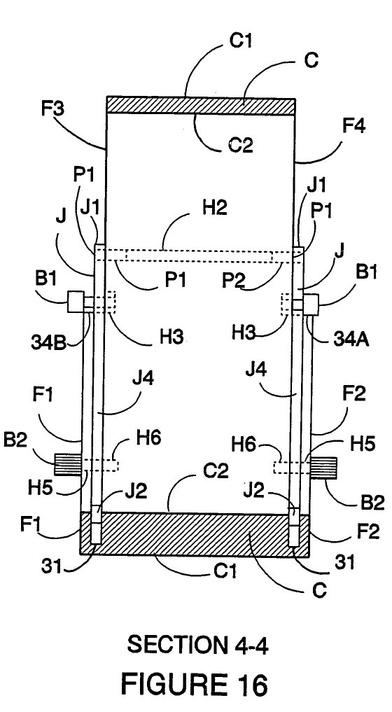

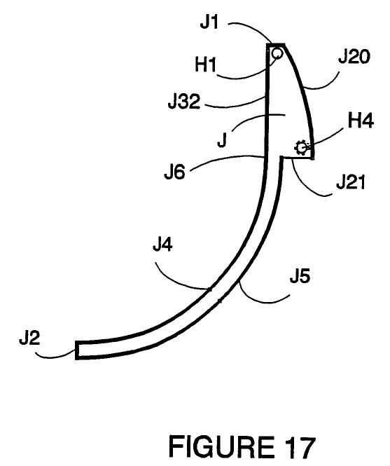

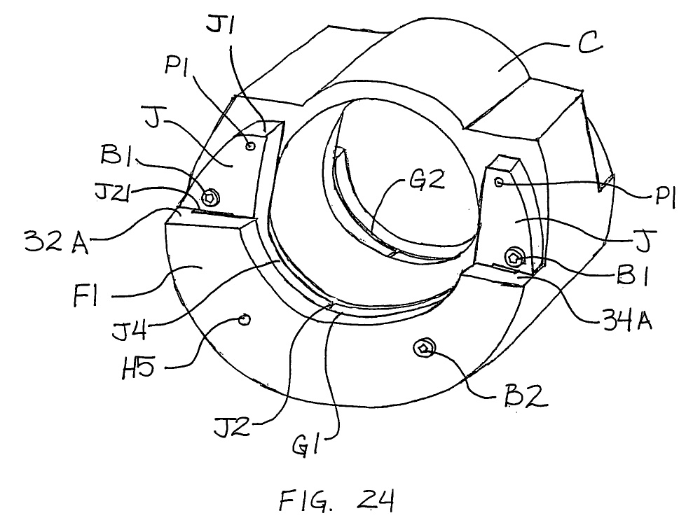

FIGS. 15 to 17 and 24 can be studied together. FIG. 15 depicts an end of a coupling body similar to that of FIG. 8 where a portion of the end portion of the coupling body normally forming a half of the internal radial groove between 32A and 34A is removed, and the top portion of the coupling between C1 and C2 is thinned out for weight reduction of the coupling. The coupling of FIG. 15 is shown in perspective in FIG. 24. The power arm and the weight arm of the lever jaw J are integrated in the same plane as a monolithic lever jaw J as shown in FIG. 17. FIG. 17 shows lever jaw J delineated by its sides J1, J4, J2, J5, J21 and J20. The lever jaw J is depicted between its two ends J1 and J2 and between its inner and outer arcuate portions J4 and J5 in FIG. 15. The length of the arcuate portion between J1 and J2 preferably is a quarter circle. The side J32 preferably emerges as a tangent with J4 at a point J6. The imaginary radially extended side between J7 and J21 toward the center of the coupling will make a ninety degree angle with side J32. Side J20 preferably conforms to the outer interrupted diameter C1 of the coupling C. Each pin P1 extends into a receiving hole in the coupling body to pivotally mount a jaw J to the body of the coupling and also act as the fulcrum for the power and the weight arms of the lever jaw J. Pins P1 can also take the form of a screw or bolt threaded into the receiving hole. Pins P1 can rotate with lever jaw J or lever jaw J can rotate in relation to pin P1. If the pins are inserted into the hole in the coupling body to rotate therein, a pin P1 is inserted through opening H1, FIG. 17, in the lever arm or jaw J and is secured therein such as by a press fit or by welding. The end of the pin extending from the jaw J is inserted into coupling body receiving hole H2 shown in FIG. 16. The positioning of the jaw J in the coupling body groove will hold the jaw and pin in hole H1 during use. If pin P1 takes the form of a screw or bolt, hole H1 will be threaded to receive the screw or bolt which can either rotate in hole H1 as the jaw is moved between engaged and disengaged positions and/or jaw J can freely rotate about the screw or bolt.

Screws depicted by B1 are threaded through holes H4, FIG. 17, through jaws J into receiving holes H3, FIG. 16, in the body of coupling C to lock jaw J in engaged position inside a pipe groove of a pipe received in the coupling body. Receiving holes H3 may be threaded or unthreaded. By receding each screw B1 so it does not extend beyond jaw J into hole H3 in the coupling body, jaw J is free to rotate about pin P1. Screw B1 can then be used as a handle to rotate jaw J about pin P1 between engaged and disengaged positions. In this embodiment, screw B1 forms the end of the power arm which extends between pin P1, the fulcrum, and screw B1. The weight arm is the entire length of jaw J between pin P1 and jaw end J2. Additional locking screws B2 may be provided, if desired, to lock the jaw J in engaged position. A hole H5 extends through coupling body face F1, FIG. 15, into the internal groove and is aligned with a threaded hole H6, FIG. 16. With jaw J in engaged position, screw B2 is inserted through hole H5 and the internal groove and is threaded into hole H6 in the body of the coupling. Screw B2 will then lock jaw J in engaged position. Either hole H5 or hole H6, or both holes, are threaded. A tab or other handle can be provided in place of screw B1 to form the end of the power arm and allow manipulation of the lever jaw J between engaged and disengaged positions. In such case, screw B2 can be provided to lock the jaw J in engaged position.

FIG. 16 depicts a vertical section taken on the line 4-4 of FIG. 15. The outer walls of the internal grooves at two ends of the coupling body are shown by F1 and F2. The top narrow half portion of the coupling is shown between faces F3 and F4 and the thinned outer wall is shown at the top of FIG. 16 between C1 and C2. The thicker wall of the coupling which contains the internal grooves is shown at the bottom of FIG. 16 between C1 and C2. Hole H2 maybe a through hole extending completely through the coupling body.

The coupling of FIGS. 15-17 provides an integrated power and weight arm forming jaw J which is easier and less expensive to manufacture than the separate power and weight arms assembled on a shaft to provide the sets of lever arm members for the embodiments of FIGS. 1-9. They are also lighter than the sets of lever jaw members. Also, the particular design of jaw J shown in FIGS. 15-17 provides a cap for the exposed open ends of the internal grooves of the coupling. Further, as previously mentioned, it has been found that with the portion of the end of the coupling body forming the internal groove cut away in the recessed portion to provide the internal groove over only about half of the coupling, i.e., over about one hundred eighty degrees, not only is weight reduced, but if the grooved portion of the coupling end is positioned at the lower side of the coupling, that grooved end portion of the coupling acts as a platform upon which a pipe to be inserted into the coupling body can rest in preparation for insertion into the coupling body.

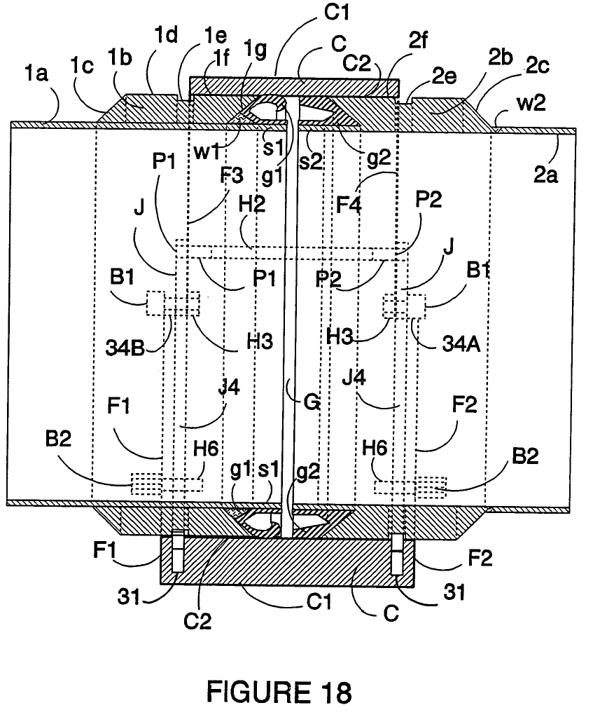

FIG. 18 is a vertical longitudinal section of the coupling of FIG. 16 showing the two ends of the coupling and showing the coupling provided with two “U” type gasket seals g1 and g2. Gasket seals g1 and g2 are mounted against confronting slanted faces of two rings 1b and 2b provided in the front end portions of opposite ends of two pipes 1a and 2a received in the coupling body. In the embodiment of FIG. 18, rings 1b and 2b are provided with surfaces for welding the rings to the pipes. Thus, ring 1b is welded to pipe 1a with weld w1 and ring 2b is welded to pipe 2a with weld w2. Pipe 1a provides seat s1 for the gasket g1, and ring 2b provides seat s2 for gasket g2. Jaws J4 are shown at the bottom of FIG. 18 in engaged positions in grooves 1e and 2e of rings 1b and 2b. Jaws J4 can be locked in these engaged positions in grooves 1e and 2e by screws B1 and/or B2 as previously described. Jaws J4 can be unlocked and rotated about pins P1 to their disengages positions out of grooves 1e and 2e to allow the pipes with rings 1b and 2b to be removed from the coupling. In disengaged position, the ends of jaws J4 as shown in grooves 1e and 2e at the bottom of FIG. 18 will be received entirely in the coupling internal groove.

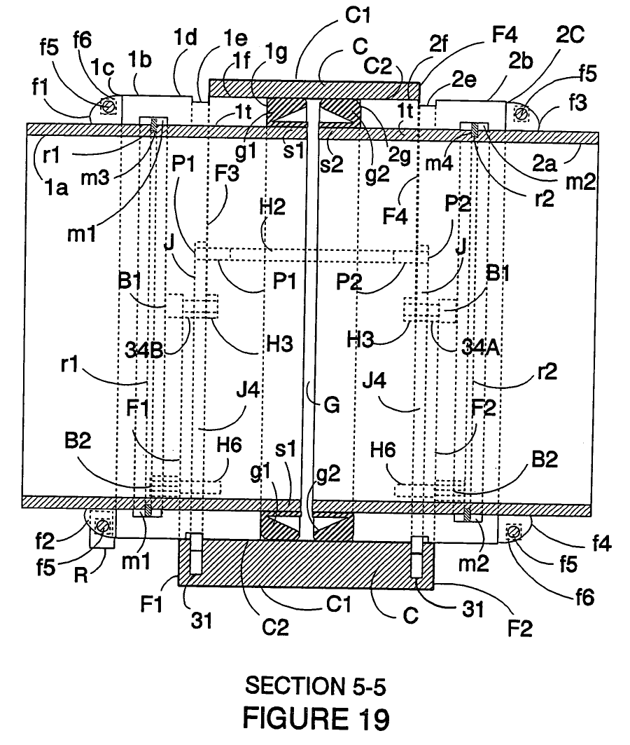

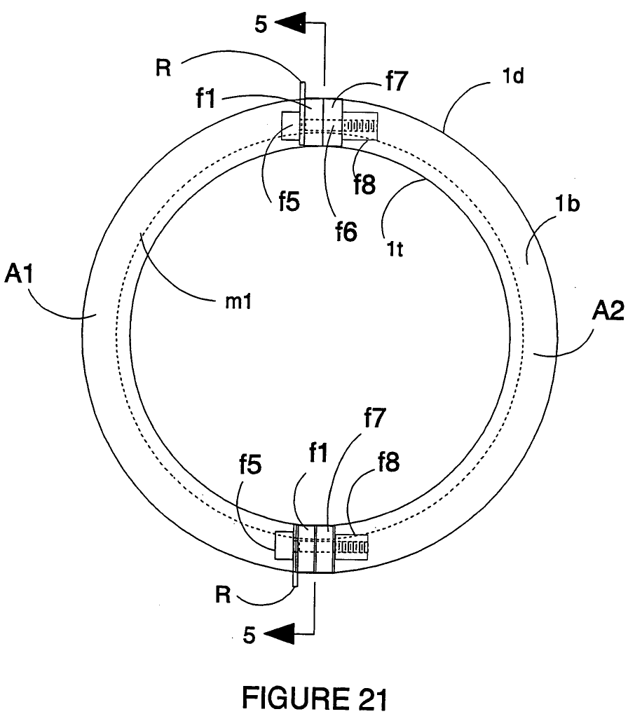

FIGS. 19, 20 and 21 will be explained together. Rather than rings 1b and 2b which provide the pipe grooves 1e and 2e for cooperation with the jaws of the coupling being welded to pipes 1a and 2a as shown in FIG. 18, the rings are split into two arcuate halves A1 and A2, shown in FIG. 21. Thus, rings 1b and 2b each take the form of split rings which are placed over and secured to the ends of pipes to be coupled using the coupling of the invention. FIG. 19 shows additional split rings r1 and r2, preferably metallic, embedded into grooves m3 and m4 grooved around the end portion of each of pipes 1a and 2a to which rings 1b and 2b are to be attached. This embodiment is particularly useful with plastic pipes, such as PVC or polyethylene pipes, where rings r1 and r2 can be embedded in the end portions of the pipe. The halves of rings 1b and 2b are then placed and secured over the rings r1 and r2 by bolting two opposite sets of flanges f1 and f7 together by means of bolts shown by bolt heads f5, stem f6 and nuts f8, FIG. 21. Rings r1 and r2 are received in grooves m1 and m2 of rings 1b and 2b, respectively, to attach rings 1b and 2b to the pipe end portions. Rings r1 and r2 serve as stop rings to prevent rings 1b and 2b from sliding off the ends of the pipes 1a and 2a and either prevent relative sliding movement of the rings 1b and 2b with respect to pipes 1a and 2a or to allow limited sliding movement of the rings 1b and 2b with respect to pipes 1a and 2a. The grooves m1 and m2 are preferably wider than rings r1 and r2. This allows limited sliding movement to accommodates thermal expansion of the pipes 1a and 2a by allowing rings r1 and r2 to slide longitudinally in receiving grooves m1 and m2 which allows pipes 1a and 2a to slide with respect to assembled rings 1b and 2b. The rings can be mounted at the site of work or in the factory. The rings 1b and 2b and coupling body in FIG. 19 may be made of metals or of the same material as pipes, but the lever jaws J are preferably always made of metal. The split of rings 1b and 2b parallel to the axis of the pipe may be spot welded.

The front portions 1f and 2f of the rings 1b and 2b are sized and configured to be received inside the coupling body C in the same manner the ends of pipe are received in the coupling body. The rings 1b and 2b are engaged within the coupling body by the jaws J engaging grooves 1e and 2e as described. Stopper washers R also shown in FIG. 21 may be provided to restrict the movement of the coupling body C beyond points 1c and 1c of FIGS. 19, 20, and 22. Stopper washer R is shown at the right bottom ring connection in FIG. 19.

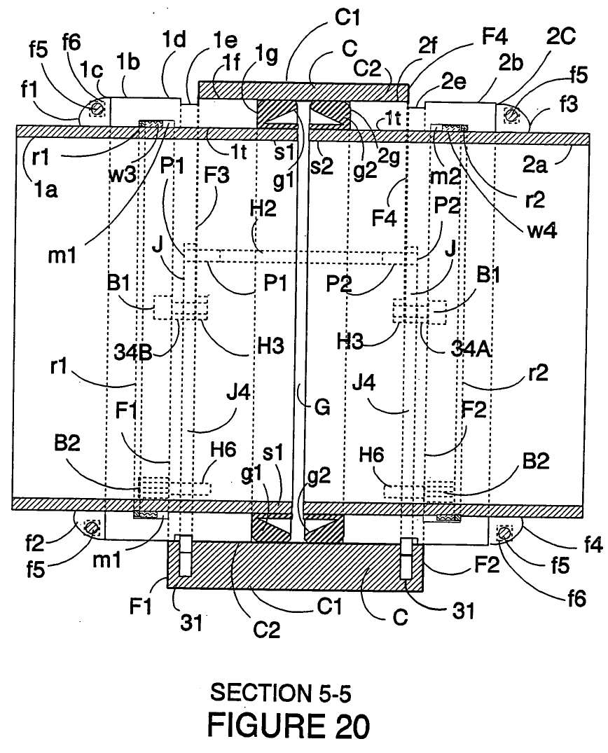

The embodiment of FIG. 20 is very similar to FIG. 19, the only difference is that the pipe in FIG. 20 is metallic pipe. The rings r1 and r2 are welded to the end portions of pipes 1a and 2a with weld w3 and w4. The mounting of the arcuate halves A1 and A2 of rings 1b and 2b around welded rings r1 and r2 is the same as discussed under FIG. 19. The function of grooves m1 and m2 is the same as in FIG. 19 to accommodate the thermal expansion of the metallic pipes 1a and 2a. The split between A1 and A2 may be welded. The rings can be mounted at the site of work or in the factory.

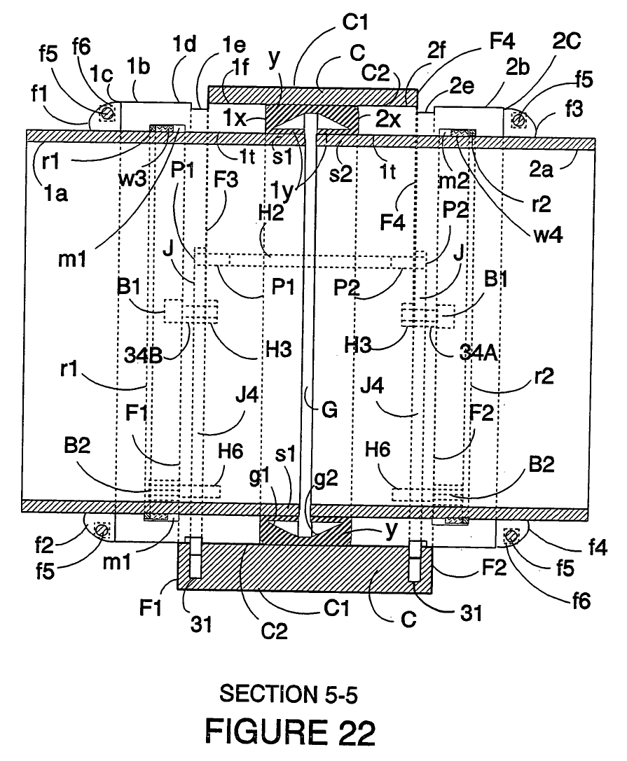

FIGS. 19 and 20 both show two “U” type opposite seals mounted in front of the vertical faces of the opposite rings 1b and 2b. These seal the coupling to prevent leakage of fluid flowing in the pipes at the coupling. FIG. 22 shows a single gasket Y rather than the two gaskets g1 and g2 of FIGS. 19 and 20. The single gasket has sides 1x and 2x which press against vertical faces of the opposite rings 1b and 2b, and the gasket opens toward the center of the coupling. Either the sloped faces of FIG. 18 or the vertical faces of FIGS. 19, 20, and 22 can be used in any of the embodiments with appropriate gaskets.

In FIG. 21, the outer and inner diameters of split ring 1b are shown by 1d and 1t. Preferably a rectangular stopper washer R will be provided to prevent the slippage of the coupling beyond points 1c and 1c during mounting and dismounting of the coupling and for that purpose, length of the rings 1b and 2b will be adjusted to the length of the coupling. Stopper washer R is also shown at the right bottom ring connection in FIG. 19.

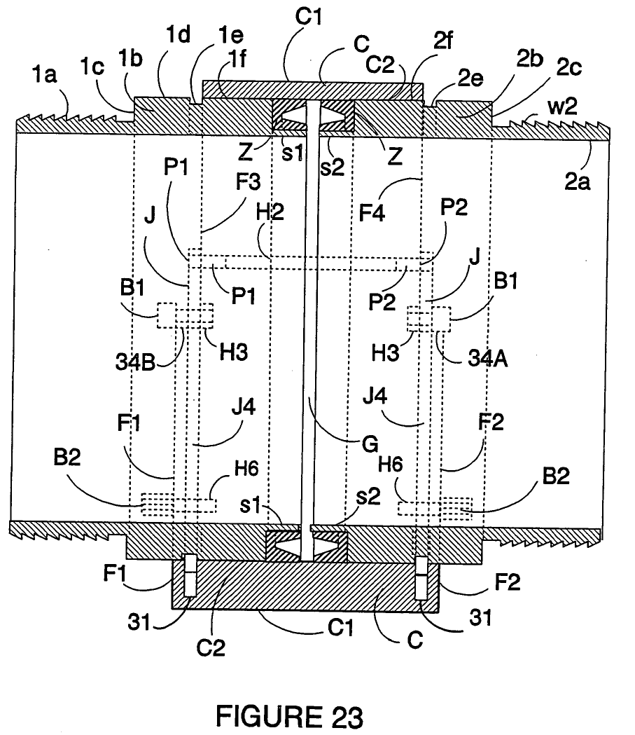

FIG. 23 shows two hose end shanks 1a and 2a which substitute for the pipes 1a and 2a in the prior figures and to which the ring configuration of rings 1b and 2b are integrally molded. These shanks are attached in normal manner to flexible hose or pipe to form the properly sized and configured ends for use with the coupling of the invention. Such shanks could also be molded into molded plastic pipe to form the ends of such pipe.

The coupling of the invention is also suited for use with a flange, such as shown in pending U.S. application Ser. No. 10/446,302, which is secured, such as by welding, to the end of a pipe to provide the grooved, properly sized and configured pipe ends for use with the coupling of the invention, and to provide an advantageous sealing surface for confronting joined pipe ends within the coupling.

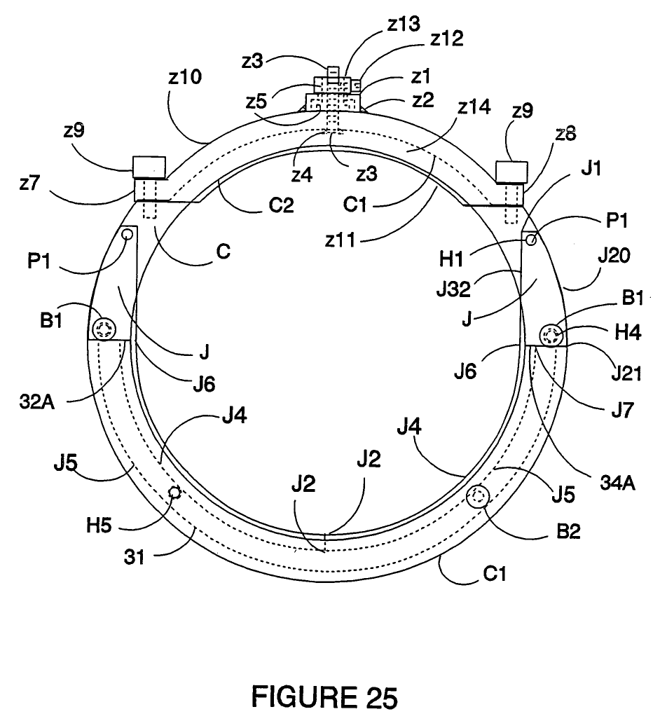

FIG. 25 shows the coupling embodiment of FIG. 15 with an additional insert or bridge z10 mounted over the reduced thickness section of coupling body C. When in the form of a bridge, the bridge will extend for the axial length of the coupling body and have two opposite sides wall z14, one at each end of the coupling body positioned in the recessed end portions of the coupling body, and each with an inner side wall edge z11. When the bridge is mounted, as shown, to the coupling body, side wall edges z11 extend into the grooves of the two opposite pipes being connected by the connector (pipes are not shown). Outer flanges z7 and z8 of the bridge are held in place by bolts z9. Alternately, pins could be used in place of bolts z9. Generally, a bridge will only be used for larger size couplings for larger size pipe, such as pipes of twenty four inch diameter or larger and where high pressures tending to pull the pipes apart can be expected. Generally also in installations with larger pipes, the coupling will be installed in the position depicted in FIG. 25 so that the grooved portion of the coupling end is at the bottom of the coupling installation and the bridge will be installed at the top of the coupling. This makes installation of the bridge relatively easy. The bridge can be secured to the coupling by a bolt extending through the bridge into the top of the coupling or into a threaded nut secured to the coupling such as in the position of z3 shown in FIG. 25, or in order to easily raise and lower the bridge to engage or disengage the pipe ends, a vise arrangement can be provided.

A vise arrangement is shown in FIG. 25 constructed of a threaded stem z3 extending through the bridge from attachment to the coupling body and a bolt z5 installed in a housing z1 secured to the outside of the bridge. Housing z1 is shown welded to the bridge with weld z2, and stem z3 is shown welded to coupling body C with weld z4. Outside of the housing z1 unthreaded nut z13 is connected to bolt z5 by means of a screw or a pin z12, or z5 and z13 can be welded together. When nut z13 is rotated counter clockwise, the bridge is raised upward away from the coupling body which raises the side walls z14 and the side wall edges z11 from the pipe grooves of the pipe end portions received in the coupling. This simultaneously frees the two connected pipes from the bridge's engagement. Clockwise rotation of nut z13 lowers the bridge toward the center of the coupling and simultaneously moves the side wall inner edges z11 of sides wall z14 into the grooves of the pipes to engage the pipes in the coupling. Alternately, rather than the side wall z14 themselves engaging the pipe grooves, flat jaws, like jaws V in FIG. 12, can be secured inside and against bridge side walls z14 to extend beyond the side wall edges z11 to extend into and engage the pipe grooves when the bridge is lowered. The flat jaws can be secured to the side walls z14 in any suitable manner such as by pins or screws extending through the side walls into the jaws. With such an arrangement, the flat jaws may hold the top portion of the pipes where they engage the pipe grooves more similarly to the way the jaw members J hold the lower portion of the pipes where they engage the pipe grooves to thereby provide more even holding pressure to the pipe grooves if desired for particular applications.

It is understood that one end of the invented coupling may have a different type of connection, such as a flange connection, a threaded connection, a ring connection, or any other type of jaw connection, to meet different requirements and conditions in making connections with pipes, hoses, pipe and hose fittings, and valves. For dead ends, the coupling is used as a one ended coupling which is provided with a blocking dead end plate. It is further understood that sizes, proportions, and shapes of the various components can vary and that the respective lengths of the lever arms can vary and can be shorter or longer than shown.

It should also be understood that the coupling of the invention can be modified and can be used in many applications not listed here. While the coupling of the invention has been described in connection with connecting pipes designed for fluid flow, the pipes can represent various other types of elements to be joined. Thus, the couplings can be used to connect other elements such as to connect structural pipes, beams, or rods. Structural elements can be structural elements of towers so the coupling of the invention can be used to couple towers such as electric or windmill towers to their bases. By providing a dead end on one side of the coupling the coupling can be used for fluid pressurized vessels, structural posts, beams, power or wind power towers, and other towers for other usages. The central bore of the coupling can be modified to any desired geometry and it does not need to be cylindrical.

Whereas the invention has been described with respect to the presently preferred illustrated embodiments, it should be understood that various changes may be made in adapting the invention to different embodiments without departing from the broader inventive concepts disclosed herein and comprehended by the claims that follow.

1. A coupling for attachment to the end portion of a pipe, comprising:
a coupling body to closely axially receive the end portion of the pipe to be coupled therewith;
at least one axle extending axially from an end thereof supported in an end of the coupling body with no further support from the coupling body; and
at least one lever jaw member mounted on the at least one axle, said at least one axle forming a fulcrum for rotation of the at least one lever jaw member about the fulcrum where rotation of the at least one lever jaw member about the fulcrum moves the at least one lever jaw member between an engaged position with respect to the end portion of the pipe when the pipe is received in the coupling body to hold the pipe in the coupling body and a disengaged position with respect to the end portion of the pipe when the pipe is received in the coupling body allowing the end portion of the pipe to be removed from the coupling body or inserted into the coupling body.

2. A coupling for attachment to the end portion of a pipe according to claim 1, wherein the axle is a bolt secured at one end to the coupling body.

3. A coupling for attachment to the end portion of a pipe according to claim 1, wherein the axle is a pin rotatably received in a receiving hole in the coupling body.

4. A coupling for attachment to the end portion of a pipe according to claim 1, wherein the at least one lever jaw member is a set of first class lever jaw members having a power arm and a separate weight arm mounted in fixed relative positions on the at least one axle forming the fulcrum, whereby rotation of the power arm about the fulcrum causes simultaneous rotation of the weight arm about the fulcrum to the engaged position or to the disengaged position with respect to the end portion of the pipe when the pipe is received in the coupling body.

5. A coupling for attachment to the end portion of a pipe according to claim 4, additionally including a sleeve mounted on the axle, the weight arm and the power arm being mounted on the sleeve in a manner to prevent rotation of the weight arm with respect to the sleeve and the power arm.

6. A coupling for attachment to the end portion of a pipe according to claim 5, wherein the sleeve is polygonal.

7. A coupling for attachment to the end portion of a pipe according to claim 6, wherein the power arm is removably mounted on the sleeve.

8. A coupling for attachment to the end portion of a pipe according to claim 1, wherein the coupling has opposite coupling body ends and joins two pipes in end to end relationship, each pipe having an end portion, wherein the coupling body is adapted to closely receive the end portion of each of the two pipes to be joined in end to end relationship, the at least one axle and the at least one lever jaw member being located with respect to one end of the coupling body to engage the end portion of one of the two pipes to be joined, the coupling further including at least one axle extending axially from an end thereof supported in the opposite end of the coupling body with no further support from the coupling body, at least one second lever jaw member mounted on the at least one axle extending from the opposite end of the coupling body, said at least one axle forming a fulcrum for rotation of the at least one second lever jaw member about the fulcrum where rotation of the at least one second lever jaw member about the fulcrum moves the at least one second lever jaw member between an engaged position with respect to the end portion of the other of the two pipes to be joined when the other pipe is received in the coupling body to hold the other pipe in the coupling body and a disengaged position with respect to the end portion of the other pipe when the other pipe is received in the coupling body allowing the end portion of the other pipe to be removed from the coupling body or inserted into the coupling body.

9. A coupling for attachment to the end portion of a pipe, comprising:
a coupling body to closely receive the end portion of the pipe to be coupled therewith, said coupling body having an end with a pipe receiving opening into which the end portion of the pipe to be coupled is inserted and having a grooved end portion extending partially around the receiving opening with an internal groove therein and a recessed end portion extending partially around the opening; and
at least one jaw member configured for movement in the internal groove in the grooved end portion to a position engaging the end portion of the pipe when the pipe is received in the coupling body to secure the end portion of the pipe in the coupling body.

10. A coupling for attachment to the end portion of a pipe according to claim 9, wherein the at least one jaw member received in the internal groove is a lever jaw member pivotally mounted to the coupling body by an axle extending from the coupling body in the recessed end portion, said axle forming a fulcrum for rotation of the lever jaw member about the fulcrum and the lever jaw member extending into the groove in the grooved end portion, rotation of the lever jaw member about the fulcrum moving the lever jaw member between the engaging position with respect to the end portion of the pipe when the pipe is received in the coupling body and a disengaging position with respect to the end portion of the pipe when the pipe is received in the coupling body allowing the end portion of the pipe to be removed from the coupling body or inserted into the coupling body.

11. A coupling for attachment to the end portion of a pipe according to claim 10, wherein the at least one jaw member configured for movement in the internal groove is movable in the internal groove between a position spaced radially from the received pipe to allow the pipe to move into or out of the coupling body and a position securing the pipe in the coupling body.

12. A coupling for attachment to the end portion of a pipe according to claim 11, wherein the at least one jaw member includes a camming surface and is mounted in the internal groove so that the camming surface interacts with a mating camming pin secured in the groove.

13. A coupling for attachment to the end portion of a pipe according to claim 12, wherein the camming surface of the at least one jaw member is a camming slot in the at least one jaw member and the camming pin extends through the camming slot.

14. A coupling for attachment to the end portion of a pipe according to claim 9, wherein the at least one jaw member is removably received in the internal groove.

15. A coupling for attachment to the end portion of a pipe according to claim 14, wherein the internal groove opens to outside the coupling body and wherein the at least one jaw member is removably slid into the internal groove to the position to secure the pipe received in the coupling body in the coupling body.

16. A coupling for attachment to the end portion of a pipe according to claim 9, additionally including the pipe inserted into the coupling body, and wherein the end portion of the pipe inserted into the coupling body is formed by a ring attached to the end portion of the pipe, said ring having an internal opening, a front cylindrical outer ring surface of desired dimensions to closely fit into the coupling body, a front surface defining the front end of the ring extending between the internal opening and the front cylindrical outer ring surface configured for seating a selected gasket, a rear cylindrical outer ring surface, and a groove between the front and rear cylindrical surfaces sized and configured to receive the at least one jaw member of the coupling.

17. A coupling for attachment to the end portion of a pipe, comprising:
a coupling body to closely receive the end portion of the pipe to be coupled therewith, said coupling body having an end with a pipe receiving opening into which the end portion of the pipe to be coupled is inserted and having a grooved end portion extending partially around the receiving opening with a groove therein and a recessed portion extending partially around the opening; and
at least one lever jaw member having a power arm and a weight arm mounted on an axle supported by the coupling body and positioned so that the a portion of the weight arm of the lever jaw member is positioned in the groove, said axle forming a fulcrum for rotation of the at least one lever jaw member about the fulcrum where rotation of the power arm about the fulcrum causes rotation of the weight arm about the fulcrum between an engaged position and a disengaged position with respect to the end portion of the pipe when the pipe is received in the coupling body.

18. A coupling for attachment to the end portion of a pipe according to claim 17, wherein the at least one lever jaw member is a single piece jaw member including both the power arm and the weight arm.

19. A ring for attachment to the end portion of a pipe to form a grooved pipe end portion of a desired size and configuration for use with a pipe coupling of the type having a coupling body which closely receives the end portion of the pipe to be coupled and includes at least one jaw member which fits into a groove in the end portion of the pipe to be joined to attach the pipe to the coupling, comprising:
a ring having an internal opening, a front cylindrical outer ring surface of desired dimension to closely fit into a selected coupling body, a front surface defining the front end of the ring extending between the internal opening and the front cylindrical outer ring surface configured for seating a selected gasket, a rear cylindrical outer ring surface, and a groove between the front and rear cylindrical surfaces sized and configured to receive the at least one jaw member of the selected coupling to attach the pipe to the coupling; and
means for securing the ring to the end portion of the pipe.

20. A ring for attachment to the end portion of a pipe according to claim 19, wherein the means for securing the ring to the end portion of the pipe includes surfaces on the ring adapted to be welded to the end portion of the pipe.

21. A ring for attachment to the end portion of a pipe according to claim 19, wherein the internal opening receives the end portion of the pipe to which the ring is to be attached, and wherein the means for securing the ring to the end portion of the pipe includes surfaces on the ring adapted to be welded to the end portion of the pipe.

22. A ring for attachment to the end portion of a pipe according to claim 19, wherein the internal opening receives the end portion of the pipe to which the ring is to be attached, wherein the ring is split into arcuate pieces having ends, and wherein the means for securing the ring to the end portion of the pipe includes means for attaching the ends of the arcuate pieces to form the ring around the end portion of the pipe.

23. A ring for attachment to the end portion of a pipe according to claim 22, wherein the means for attaching the ends of the arcuate pieces include flanges at the ends of the arcuate pieces which are bolted together to form the ring around the end portion of the pipe.

24. A ring for attachment to the end portion of a pipe according to claim 22, wherein the means for securing the ring to the end portion of the pipe additionally includes a stop ring secured to the pipe, and an internal groove in the ring which fits over and receives the stop ring, cooperation of the stop ring and the groove preventing the ring from sliding off the end portion of the pipe.

25. A ring for attachment to the end portion of a pipe according to claim 24, wherein the internal groove is larger than the stop ring to allow limited sliding movement of the pipe with respect to the ring to compensate for pipe expansion and contraction.

26. A ring for attachment to the end portion of a pipe according to claim 19, wherein the ring is a single piece, and wherein the means for securing the ring to the end portion of the pipe includes a shank for insertion into the end of a flexible pipe.
